(19) United States
(12) Patent Application Publication
(10) Pub. No.: US 2008/0075041 A1
(43) Pub. Date: Mar. 27, 2008

(54) Method and apparatus for distribution and attachment gateway support node in wireless communications system

(75) Inventor: Yu-Chih Jen, Taipei city (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited, Tortola (VG)

(21) Appl. No.: 11/905,098

(22) Filed: Sep. 27, 2007

Related U.S. Application Data
(60) Provisional application No. 60/847,366, filed on Sep. 27, 2006.

(51) Int. Cl. H04Q 7/00

(52) U.S. Cl. 370/329

(57) ABSTRACT

To provide load balance, low interruption, reduced amount of PDP context (or similar context) creation request messages, and flexibility in an LTE/SAE wireless communications system, a method of distributing a gateway support node in the LTE/SAE wireless communications system includes utilizing an entity to perform a first function for collecting information about statistics, characteristics, and status of a GGSN-functional-like entity (GFL) and connections related to the GFL, and utilizing the entity to perform a second function for processing the GFL inventory according to the information collected by the first network node.

### CROSS REFERENCE TO RELATED APPLICATIONS

This application claims the benefit of U.S. Provisional Application No. 60/847,366, filed on Sep. 27, 2006 and entitled “Method and Apparatus for Distribution and Attachment Gateway Support Node in Wireless Communications System,” the contents of which are incorporated herein by reference.

### BACKGROUND OF THE INVENTION

1. Field of the Invention

The present invention relates to methods of distributing gateway support nodes in wireless communications systems and related communications devices, and more particularly, to methods of distributing gateway support nodes in LTE and related communications devices.

2. Description of the Prior Art

In a universal mobile telecommunications system (UMTS), before accessing a service in external network, a user equipment (UE) generally needs to perform a packet data protocol (PDP) context activation procedure to activate PDP contexts (routing information for tunneling packets) to a belonging serving general packet radio service (GPRS) support node (SGSN) and a specific gateway GPRS support node (GGSN), which can support the service. Each service is referred to or mapped to an access point name (APN). Basically, the SGSN connecting UMTS terrestrial radio access networks (UTRANs) provides packet switching functionality by making use of the PDP context for tunneling packets of attached UEs between UEs and the GGSN throughout supporting networks. On the other hand, with usage of a maintained PDP context, the GGSN, which connects GPRS/UMTS networks (internal networks including UEs and corresponding SGSNs) with external networks, e.g. the Internet, as a functional router and gateway, provides address mapping, packet switching and tunneling, packet counting, and routing between connected networks (from internal to external, or external to internal).

Please refer to FIG. 1, which is a diagram of a wireless communications system 10 according to the prior art. The wireless communications system 10 comprises a GGSN 12, an SGSN 14 coupled to the GGSN 12, and a RNS 16 coupled to the SGSN 14. The RNS 16 is wirelessly connected with a UE 18. Through the RNS 16, the SGSN 14, and the GGSN 12, the UE 18 is able to access an external network 19, such as the Internet.

During the PDP context activation procedure initiated by the UE 18, the UE 18 will, based on the access service, send the corresponding APN and related quality of service (QoS) Profile to the SGSN 14. Then, the SGSN 14, upon reception of the requested APN content, will query a domain name system (DNS) for an inventory recording addresses of proper and supporting GGSNs, such as the GGSN 12, where the GGSNs in the inventory should provide the service. After receiving the set of listed GGSNs, the SGSN 14 will choose one GGSN, such as the GGSN 12, from the inventory and send the request for activating the PDP context to the one GGSN. If for some reason the SGSN 14 receives a rejection message in a “create PDP context response”, the SGSN 14 will submit a request to the next GGSN in the inventory, until the PDP context creation request is accepted by an available GGSN or the SGSN procedure runs out of GGSN addresses before being accepted, which is the worst case scenario.

3GPP has set forth a roadmap for evolution of UMTS/HSPA from Release '99 through Release 7 with developmental and standardization work in place. “Mobile Broadband: The Global Evolution of UMTS/HSPA—3GPP Release 7 and Beyond” explores Release 7 and the future beyond HSPA (UMTS/HSDPA/HSUPA) with HSPA Evolution (HSPA+), Long Term Evolution (LTE), and System Architecture Evolution (SAE) initiatives.

In LTE/SAE, new network architecture and functional entities are discussed and working assumptions are being finalized. One big difference is that the radio network controller (RNC), part of the RNS 16, no longer exists in LTE/SAE, as its functions could either split into an evolved NodeB (eNB) and an access gateway (aGW) or completely move into eNB. The eNB and the aGW maintain original functions in NB and SGSN (probably GGSN), respectively, with addition of new functions to provide packet-switching-domain-only services. It is also assumed that an evolved packet core contains a 3GPP anchor and an SAE anchor in addition to the aGW, while an Evolved Radio Access Network (RAN) contains the eNBs and the UEs.

Before the realization of LTE/SAE, it is expected that the HSPA+ provide a smooth path for transition from UMTS/HSPA to LTE/SAE. Indeed, important milestones are achieved in 3GPP Release 6 with an IP Multimedia Subsystem (IMS), High-Speed Download Packet Access (HSDPA) enhancements, High-Speed Upload Packet Access (HSUPA), WLAN integration and IP Transport. HSPA+ further improves the HSPA, and is a bridge to the SAE. This allows for reuse of most of the work underway in LTE in terms of improvement of latency (protocol evolution and functional split), but has constraints in terms of support for legacy terminals and HW changes.

As mentioned above, it is known that the SGSN 14 may not be able to find a GGSN (is rejected by the GGSN) to attach to and create the PDP context for the service on its first attempt. Thus, it is understood that there may be repeated signalling (messages) sent back and forth to GGSN(s) in the inventory, and delay and performance degradation are expected regardless of why the GGSN does not accept requests, e.g. the GGSN is unable to meet the QoS requirements.

Possible reasons, to be clarified as examples, are several. First, transmission flows and rates can be different among various services, so it is impossible for a single GGSN to provide all kinds of services. It is more reasonable that each GGSN will only provide services for certain types of APN. Second, after the PDP context has been created for the service at the GGSN, the GGSN is not changed during the session of the service, and can only be released at the end of the session. If the GGSN is overloaded, it is very likely the service will be stopped or interrupted. Third, to solve the problem of the second reason, it is proposed in “Scalable Gateway GPRS support node for GPRS/UMTS networks,” (IEEE Vehicular Technology Conference 2002-Fall, pp. 2239-2243) that the serving GGSN be guided to a new GGSN to balance the load of the GGSN, so that the service of the UEs is not interrupted. However, the PDP contexts need to be modified in both the SGSN and the GGSN to achieve the functionality of redirection to the new GGSN, which generates more messages, and still might have the problem of temporary breaks.

It is believed that, given increasing demand for data traffic, mobile networks will be used more and more frequently for IP services. GPRS/UMTS/HSPA are important steps toward the goal of IP broadband access (HSPA+/LTE/SAE), but the network architecture is still one designed at the time of the first GPRS services.

A proposal in 3GPP TSG RAN WG2 #54 R2-062225, “HSPA+ Proposal for Architectural Evolution,” suggests a reasonable new network architecture (making use of legacy HW) and related protocol stacks, with which the framework of HSPA evolution as the path toward LTE/SAE should evolve the HSPA access network architecture towards a flat and direct IP broadband access to the core network (CN). Although it might not be finalized exactly as the agreed realization, it represents a general concept based on requirements and assumptions developed in 3GPP RP-060217, “Work Item Description on Scope of future FDD HSPA Evolution” and 3GPP TR 25.cde, “HSPA Evolution beyond Release 7”. Similar to LTE/SAE, the new architecture together with corresponding functionalities providing packet switching services call for better solutions for distribution and attachment of a GGSN-function-like (GFL) networking entity, e.g. deployment of a distributor, which connects the external network to the wireless access network. However, conclusions are yet to be made.

In UMTS, generally an SGSN serves as a mobility management entity (MME) and a user plan entity (UPE), and a GGSN serves as a user plan entity. In some cases, the UPE may consist of only the SGSN, even though the UPE most often consists of both the SGSN and the GGSN, depending on how functionalities are defined and split. In LTE, the naming of MME and UPE are defined in 3GPP TR23.882 and TS36.300. Therefore, a GFL can be a UPE, or part of a UPE, for example, according to the functionalities of the GFL or the UPE.

### SUMMARY OF THE INVENTION

A method of distributing a gateway support node in an LTE wireless communications system comprises utilizing an entity to perform a first function for collecting information about a GGSN-functional-like entity (GFL entity or entities), such as statistics, characteristics, and status of a GFL entity (or entities) and connections related to the GFL entity (or entities), and utilizing the entity to perform a second function for processing the GFL inventory according to the information collected by the first function. The entity (a distributor) comprises the two functions.

According to a second embodiment of the present invention, a method of creating PDP-context-like (PCL) information in an LTE wireless communications system comprises according to a GGSN-inventory-functional-like (GFL) inventory, a UE initiating a PDP-context-like (PCL) information activation procedure for triggering creation of PCL information at a first entity or a first entity initiating a PDP-context-like (PCL) information activation procedure for triggering creation of PCL information at itself. The first entity is an entity of an end of PCL information creation.

According to a third embodiment of the present invention, a method of creating PDP-context-like (PCL) information in an LTE wireless communications system comprises a UE initiating a PDP-context-like (PCL) information activation procedure or a first entity of a PCL information creation requests further PCL information creation needed at a second entity based on a GGSN-inventory-functional-like (GFL) inventory if more than one entity is needed for creation of the PCL information. The second entity is an entity of the smallest level able to be an entity of an end of the PCL information creation.

According to the present invention, a communications device for creating PDP-context-like (PCL) information in a wireless communications system comprises a control circuit for realizing functions of the communications device, a processor installed in the control circuit, for executing a program code to operate the control circuit, and a memory coupled to the processor for storing the program code. The program code comprises code for a communications device requesting further PCL information creation needed at a second entity based on a GGSN-inventory-functional-like (GFL) inventory, wherein the communications device is a UE initiating a PDP-context-like (PCL) information activation procedure or a first entity of a PCL information creation if more than one entity is needed for creation of the PCL information if more than one entity is needed for creation of the PCL information. The second entity is an entity of the smallest level able to be an entity of an end of the PCL information creation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communications system according to the prior art.

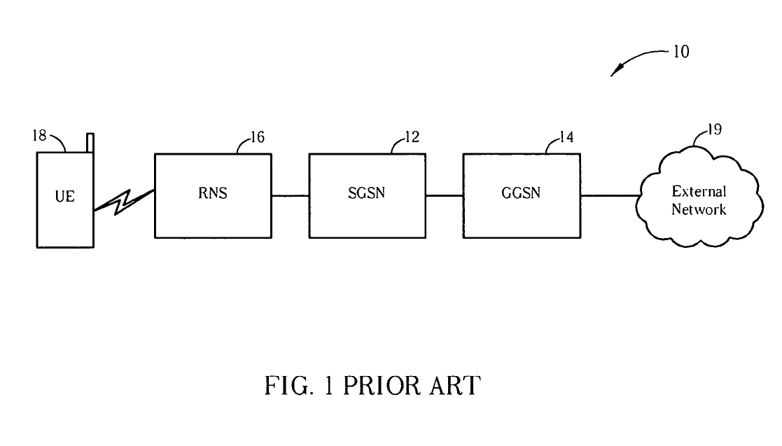

FIG. 2 is a flowchart of a process according to the present invention.

FIG. 3 is a functional block diagram of an entity carrying out the realization of FIG. 2.

FIG. 4 is a functional block diagram of entities in a same location carrying out the realization of FIG. 2.

FIG. 5 is a functional block diagram of entities in different locations carrying out the realization of FIG. 2.

FIG. 6 is a flowchart of a process according to a second embodiment of the present invention.

FIG. 7 is a flowchart of a process according to a third embodiment of the present invention.

FIG. 8 is a diagram of a communications device according to the present invention.

FIG. 9 is a diagram of program code of the communications device of FIG. 8.

### DETAILED DESCRIPTION

Due to the aforementioned problems, it is necessary to develop new functions for collecting related GGSN-functional like (GFL) node information and processing an acquirable GFL inventory based on the collected information beforehand, so that once an SGSN-functional-like node obtains the processed GFL inventory, the SGSN-functional-like node can choose a GFL node from the inventory (received locally or through other node(s)), with a high probability of acceptance by the GFL node, for sending a PDP-context-like (PCL) content creation request during a PCL content activation procedure initiated by a user equipment (UE) for accessed services.

The GFL node (entity) represents an entity, which performs functions similar to the GGSN mentioned above, with a possible extension of functions, or behaves as a router or gateway between an external network and an internal network. The SGSN-functional-like node (entity) represents an entity, which performs functions similar to the SGSN mentioned above, with a possible extension of functions.

On the other hand, an invented distributor handles two functions in an entity addressed in the following and the two functions are located in the same functional location or a network node. The invented distributor can also represent a coordinated or virtually synthesized functional block comprising the two functions if a first entity for handling the first function and a second entity for handling the second function are separately located in the same or different functional locations or network nodes. For example, the distributor can use information collected from the first entity to process the GFL inventory in the second entity. In the case of UMTS, the first entity and the second entity can form a combined entity (a distributor) with both functions located in the same functional location, e.g. DNS. The first entity and the second entity (not really synthesized as the entity) can be located in the same functional location, e.g. the GGSN. The first entity and the second entity can be located in different functional locations, such as locating the first entity in the DNS and the second entity in the SGSN. But, from an integrated view, the present invention distributor performs and represents both functions as a whole for convenience. In other words, it is understood that the distributor will process unprocessed GFL inventory originating from, for example, the DNS, based on the collected information, even though processing and collecting functions can be performed in one same entity or in multiple different entities located in different nodes or in the same network node.

The present invention provides a processed GFL inventory, in which each GFL entity has a high probability of accepting the PCL content creation request, as long as the request is sent to a choice from the GFL inventory.

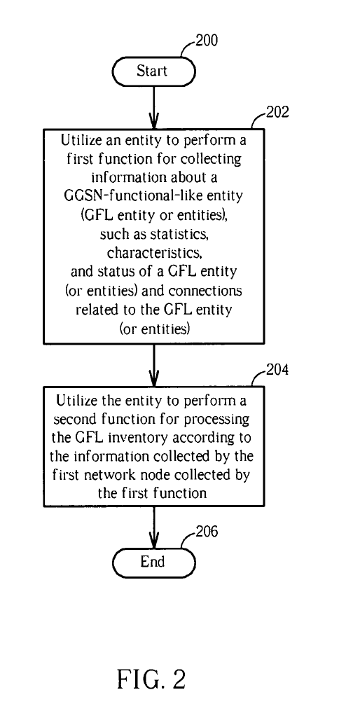

Please refer to FIG. 2, which is a flowchart of a process 20 according to the present invention. The process 20 comprises the following steps:

Step 200: Start.

Step 202: Utilize an entity to perform a first function for collecting information about a GGSN-functional-like entity (GFL entity or entities), such as statistics, characteristics, and status of a GFL entity (or entities) and connections related to the GFL entity (or entities).

Step 204: Utilize the entity to perform a second function for processing the GFL inventory according to the information collected by the first function.

Step 206: End.

In LTE/SAE, if a function (b) (Step 204) and a function (a) (Step 202) are in the same functional block, the distributor is located as one block at the DNS (level).lf the function (b) and the function (a) are in separate functional blocks, the function (b) block and the function (a) block of the distributor are located at the DNS (level) and at a network node, e.g. a new network node, IASA (or 3GPP Anchor), or aGW level, respectively.

The first entity of the creation of PCL information requiring GFL inventory for PCL information creation at a next entity is aGW or eNB, and the second entity of the creation of PCL information is IASA (or 3GPP Anchor) or aGW. Once the aGW or the eNB creates the PCL information, the aGW or the eNB can send a GFL inventory query to the DNS, which can manage an unprocessed GFL inventory, based on APN (or APN-like content), and send a request for processing of the unprocessed GFL inventory to the distributor (locally) or the function (b) block (locally). Once the DNS obtains the processed and updated GFL inventory, or once the DNS obtains the processed and updated GFL inventory generated based on information from the function (a) block at a network node, the DNS can return the processed and updated GFL inventory to the aGW or the eNB, so that the aGW or the eNB can send the PCL information creation request to a GFL entity in the processed and updated GFL inventory (normally choosing the first GFL entity (IASA (or 3GPP Anchor) or aGW after sorting with a high probability of accepting the request). If the requested GFL entity rejects the request, the aGW or the eNB can send the request to the next GFL entity in the processed and updated GFL inventory, until the request is accepted or the processed inventory is exhausted.

If the function (b) and the function (a) are in the same functional block, the distributor is located as one block at the aGW or the eNB (level). Or, if the function (b) and function (a) are in separate functional blocks, the function (b) block and the function (a) block of the distributor are located at the aGW or the eNB (level) and a network node, e.g. a new network node or at the DNS level, respectively. The first entity of the creation of PCL information requiring GFL inventory for PCL information creation at a next entity is the aGW or the eNB and the second entity of the creation of PCL information is the IASA (or 3GPP Anchor) or the aGW. Once the aGW or the eNB creates PCL information, the aGW or the eNB, if needed, can send a GFL inventory query to the DNS, which can manage an unprocessed GFL inventory based on the APN (or APN-like content), and send the inventory back to the aGW or the eNB. The aGW or the eNB can save the received inventory based on the APNs in a cumulative way (as records), so that the aGW or the eNB does not need to query the DNS for unprocessed inventory in the future if the aGW or the eNB has the GFL inventory information for a certain type of APN already. The aGW or the eNB may also query the DNS for the GFL inventories of the most often used APN types along with a normal query of a certain type of APN to maintain up-to-date information on the GFL entities (if function (a) block is at the DNS level). The aGW or the eNB with the function (b) block then processes the unprocessed GFL inventory based on the information from the function (a) block locally, or based on the information from the function (a) block at a network node, then forms the processed and updated GFL inventory locally. Then, the aGW or the eNB can send a PCL information creation request to a GFL entity in the processed and updated GFL inventory (normally choosing the first GFL entity after sorting with a high probability of accepting the request). If the requested GFL entity (IASA (or 3GPP Anchor) or aGW) rejects the request, the aGW or the eNB can send the request to the next GFL entity in the processed and updated GFL inventory until the request is accepted or the processed inventory is exhausted.

If the function (b) and the function (a) are in the same functional block, the distributor is located as one block at the IASA (or 3GPP Anchor) or the aGW (level). Or, if the function (b) and the function (a) are in separate functional blocks, the function (b) block and the function (a) block of the distributor are located at the IASA (or 3GPP Anchor) or the aGW and a network node, e.g. a new network node or at the DNS level, respectively. The first entity of the creation of PCL information requiring GFL inventory for PCL information creation at a next entity may be the aGW or the eNB, and the second entity of the creation of PCL information may be the IASA (or 3GPP Anchor) or the aGW. Once the aGW or the eNB creates PCL information, the aGW or the eNB, if needed, can send a GFL inventory query to the DNS, which can manage an unprocessed GFL inventory based on the APN, and forward the unprocessed inventory and the identity of the aGW or the eNB to the distributor at the IASA (or 3GPP Anchor) or the aGW (level) which is one IASA (or 3GPP Anchor) or aGW, e.g. the primary one, in the unprocessed inventory. The distributor will process the inventory based on information from the function (a) locally or based on information from the function (a) at a network node, and examine whether the currently located IASA (or 3GPP Anchor) or the aGW is still in the processed inventory. If the currently located IASA (or 3GPP Anchor) or the aGW is still in the processed inventory of IASAs (or 3GPP Anchors) or aGWs, the distributor will request PCL content creation locally. The request may be accepted, since the distributor is at the current IASA (or 3GPP Anchor) or the aGW and directly receiving instant up-to-date information for the processing procedure. Otherwise, the current IASA (or 3GPP Anchor) or the current aGW should already have been removed from the inventory during the processing procedure. If the currently located IASA (or 3GPP Anchor) or aGW accepts the PCL content creation request, it may directly inform the aGW or the eNB of successful creation based on the identity of the aGW or the eNB received from the DNS. If the currently located IASA (or 3GPP Anchor) or the aGW is not in the processed inventory (request may be rejected), the IASA (or 3GPP Anchor) or the aGW may redirect the request to the next (highest priority with highest probability of request acceptance other than itself) IASA (or 3GPP Anchor) or aGW, and so on and so forth, until the request is accepted or the processed inventory is exhausted. The last requested IASA (or 3GPP Anchor) or the aGW may indicate to the requesting aGW or eNB the cause for whether the PCL content creation is successful or not.

In the above, GFL entity information collected comprises, for example, system load, UE number, session number, and services. Also, the entity may process the unprocessed inventory based on, for example, priority, best performance, predetermined configuration, or system load.

If there is a third entity needed for PCL information creation, the second entity mentioned above needs to request PCL information creation at the third entity, such as an aGW-level node, a 3GPP anchor, or SAE anchor. In addition, a first GGSN-inventory-functional-like (GFL) inventory can be used at a first entity to request PCL information creation at a second entity when a second GFL inventory can be used at the second entity to request PCL information creation at a third entity. The first GFL inventory can be a processed inventory where information about the second entity is collected and then the inventory of second entities is processed. The second GFL inventory can be a processed inventory where information about the third entity is collected and then the inventory of third entities is processed. Consequently, inter-access-system services can be provided more flexibly and less-delayed. For a UE in UMTS or HSPA+, having PCL information creation at LTE architecture network node (such as 3GPP anchor, or an SAE anchor) can reduce mobility or service delay and can maintain service continuity.

A GGSN-inventory-functional-like (GFL) inventory is mainly an inventory for choosing a next or sequential-required entity of PCL information creation, e.g. last entity of PCL information creation or entity in the middle of PCL information creation. Depending on the number of levels of PCL information creation or who is making use of it, the GFL can be just a naming issue in the context.

Regarding the first entity mentioned above, the GFL inventory is unnecessary if the first entity is the entity of the end of PCL information creation. The first entity can also connect an external network and an internal network to provide routing ability. If the first entity needs the GFL inventory to request the creation of PCL information at the second entity (e.g. due to consideration of service and routing ability), the first entity can maintain, generate, or receive through another entity or by itself the GLF inventory.

It can also be mandatory for the first entity to provide the services needed at power on, or to have enough capacity (e.g. an entity combining SGSN and GGSN functional like capability). It may also be mandatory for the first entity to have abilities of examining the GFL inventory and forwarding the PCL information creation request.

Regarding the first entity as the entity of the end of PCL information creation (only one level of PCL information creation), the GFL inventory (acting conceptually such an inventory of entities for the first and only PCL information creation and GFL is just a naming issue) can be received by a UE at power on, so that the UE can choose the first priority GFL entity from the GFL inventory to request the PCL information creation at the first (and only) entity, or can be used at the first entity, so that the first entity can accept the PCL information creation request directly or forward the request to a GFL entity (as first and only PCL information creation entity with corresponding capability) in the inventory. The first entity here with corresponding capability can connect an external network and an internal network to provide routing ability.

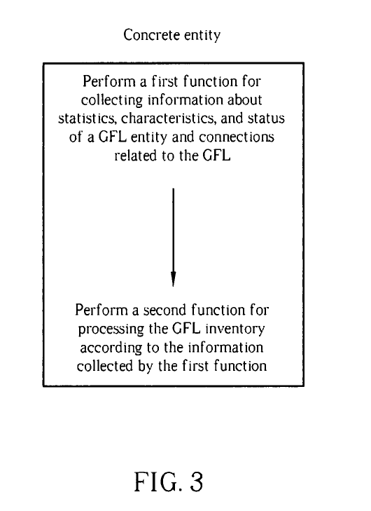

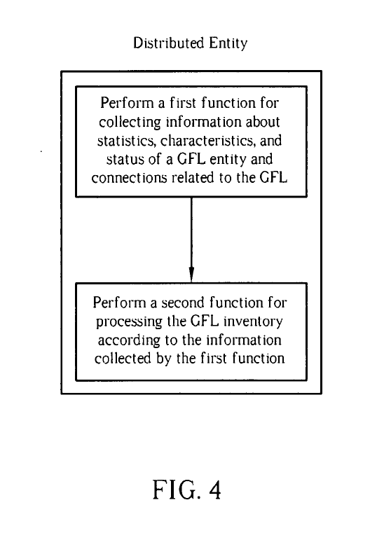

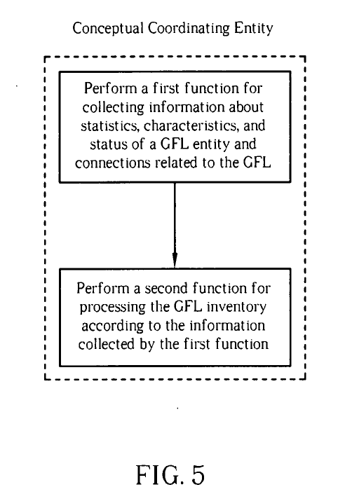

Please refer to FIGS. 3-5, which are diagrams of an entity or entities carrying out realization of the process of FIG. 2. Basically, the two functions can be implemented in an entity (module), as shown in FIG. 3, or (at least two) entities (modules), which form a coordinating (virtually synthesized) or synthesized functional entity (a distributor in functional aspect/point of view), shown in FIGS. 4-5, where the entities for the two functions are unnecessarily implemented in the same functional location/network node. In other words, the entity can either be a concrete entity performing the two functions (FIG. 3), a distributed entity comprising a first entity for performing the first function and a second entity for performing the second function in the same functional location or network node (FIG. 4), or a conceptual coordinating entity comprising at least two entities performing the two functions in different functional locations or network nodes (FIG. 5).

The first entity performs a first function for collecting information about a GGSN-functional-like entity (GFL entity or entities) such as statistics, characteristics, and status of a GGSN-functional-like entity (GFL entity or entities) and connections related to the GFL entity (entities). The second entity performs a second function for processing the GFL inventory.

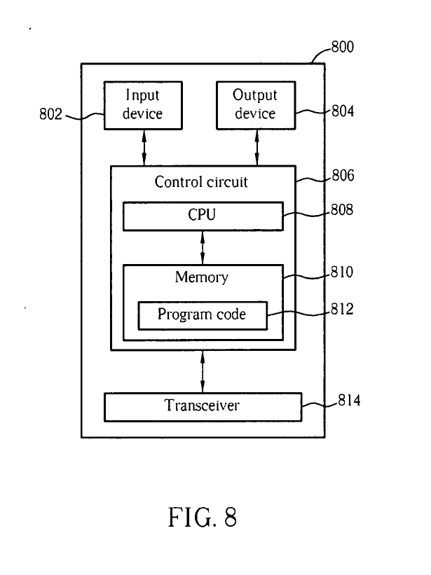

Please refer to FIG. 8, which is a functional block diagram of a communications device 800. For the sake of brevity, FIG. 8 only shows an input device 802, an output device 804, a control circuit 806, a central processing unit (CPU) 808, a memory 810, a program code 812, and a transceiver 814 of the communications device 800.

In the communications device 800, the control circuit 806 executes the program code 812 in the memory 810 through the CPU 808, thereby controlling an operation of the communications device 800. The communications device 800 can receive signals input by a user through the input device 802, such as a keyboard, and can output images and sounds through the output device 804, such as a monitor or speakers. The transceiver 814 is used to receive and transmit wireless signals, delivering received signals to the control circuit 806, and outputting signals generated by the control circuit 806 wirelessly. From a perspective of a communications protocol framework, the transceiver 814 can be seen as a portion of Layer 1, and the control circuit 106 can be utilized to realize functions of Layer 2 and Layer 3. Preferably, the communications device 800 is utilized in an LTE/SAE mobile communications system.

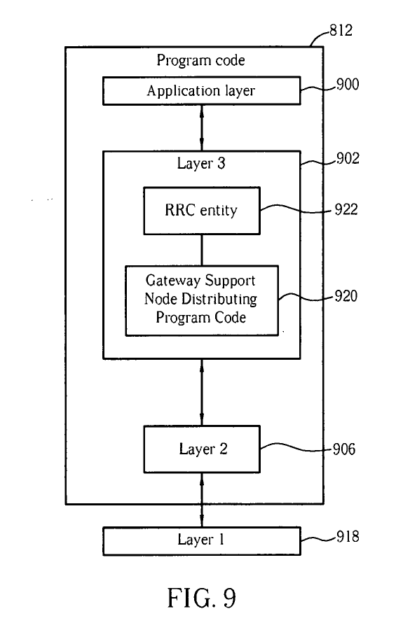

Please continue to refer to FIG. 9. FIG. 9 is a diagram of the program code 812 shown in FIG. 8. The program code 812 includes an application layer 900, a Layer 3 902, and a Layer 2 906, and is coupled to a Layer 1 918. The Layer 3 902 includes a radio resource control (RRC) entity 922, which is used for controlling the Layer 1 918 and the Layer 2 906 and performing peer-to-peer RRC communication with other communications devices, such as a base station or a Node-B-like entity. In addition, the RRC entity 922 can change an RRC state of the communications device 800, switching between an idle mode, a detached state, and an active state. The program code 812 further comprises a gateway support node distributing program code 920, which is used for distributing a gateway.

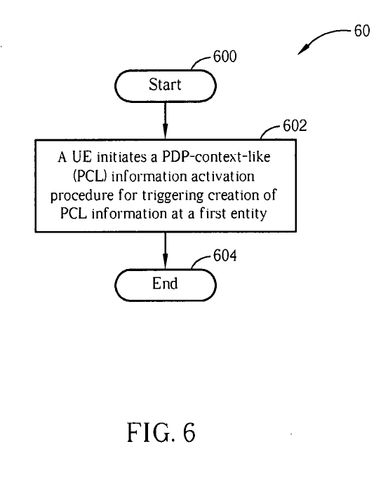

Please refer to FIG. 6, which is a flowchart of a process 60 for distributing a gateway support node in an LTE wireless communications system. The process 60 comprises the following steps:

Step 600: Start.

Step 602: A UE initiates a PDP-context-like (PCL) information activation procedure for triggering creation of PCL information at a first entity.

Step 604: End.

In the process 60, the first entity is an entity of an end of PCL information creation.

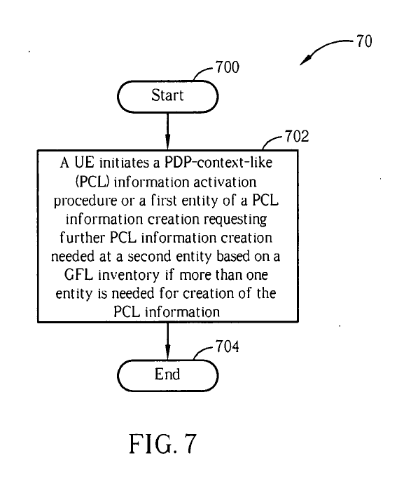

Please refer to FIG. 7, which is a flowchart of a process 70 for distributing a gateway support node in an LTE wireless communications system. The process 70 can be seen as part of the program code 920, and comprises the following steps:

Step 700: Start.

Step 702: A UE, which initiates a PDP-context-like (PCL) information activation procedure, or a first entity of a PCL information creation requests further PCL information creation needed at a second entity based on a GGSN-inventory-functional-like (GFL) inventory if more than one entity is needed for creation of the PCL information.

Step 704: End.

In the process 70, the second entity is an entity of the smallest level able to be an entity an end of the PCL information creation.

Compared to the prior art, the present invention can be used to provide load balance and low interruption, reduce the amount of PDP context (or similar context) creation request messages, and generate flexibility in wireless communications systems, such as LTE/SAE.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of distributing a gateway support node in an LTE wireless communications system, the method comprising:
utilizing an entity to perform a first function for collecting information about statistics, characteristics, and status of a GFL entity or entities and connections related to the GFL entity or entities; and
utilizing the entity to perform a second function for processing the GFL inventory according to the information collected by the first function.

2. The method of claim 1, wherein the entity performs the first function and the second function during a PDP-context-like (PCL) information activation procedure or during normal time without performing the PCL information activation procedure for preparing a quick response and maintaining up-to-date information.

3. The method of claim 1, wherein if the entity comprises a first entity for performing the first function and a second entity for performing the second function, the first entity and the second entity are located in the same functional location, different functional locations, or separate network nodes.

4. The method of claim 1, wherein the entity collects GFL entity information comprising system load, UE number, session number, QoS, coordinating information, contracting rules, or services.

5. The method of claim 1, wherein the entity processes unprocessed inventory based on the collected information, priority, best performance, predetermined configuration, contracting rules, coordinating information, or system load.

6. The method of claim 1, wherein for services of different APNs with similar characteristics and requirements, a GFL entity of a service redirects a PDP-context-like creation request to another GFL entity of another service, or a PDP-context-like creation (PCL) requesting entity queries another GFL inventory for PCL creation if the GFL inventory is exhausted or being exhausted.

7. The method of claim 1 further comprising:
utilizing the entity to examine validity of a GFL entity according to information comprising services, system load, or QoS; and
removing the GFL entity from the unprocessed GFL inventory to form a processed GFL inventory.

8. The method of claim 7 further comprising utilizing the entity to sort the processed GFL inventory to form a scheduled and updated inventory based on collected information, priority, best performance, predetermined configuration, or system load.

9. The method of claim 1, wherein the entity performing the two functions or comprising a first entity performing the first function and a second entity performing the second function is located in an aGW, an SGSN-functional-like node, a DNS-functional-like node, an IASA-functional-like node, an evolved packet core node, a GGSN-functional-like node, a 3GPP Anchor node, a new network node, or an evolved NodeB; wherein the first entity and the second entity are located in an aGW, an SGSN-functional-like node, a DNS-functional-like node, an IASA-functional-like node, an evolved packet core node, a GGSN-functional-like node, a 3GPP Anchor node, a new network node, or an evolved NodeB if the entity performs the two functions and comprises the first entity performing the first function and the second entity performing the second function.

10. The method of claim 3, wherein if the first entity and the second entity are located in different functional locations or separate network nodes, the first entity is located at an aGW, an SGSN-functional-like node, a DNS-functional-like node, an IASA-functional-like node, an evolved packet core node, a GGSN-functional-like node, an eNB, a 3GPP Anchor node, or a new network node, and the second entity is located at the aGW, the SGSN-functional-like node, the DNS-functional-like node, the IASA-functional-like node, the evolved packet core node, the GGSN-functional-like node, the eNB, the 3GPP Anchor node, or the new network node.

11. The method of claim 5, wherein if the unprocessed GFL inventory is not locally maintained, not locally generated, or not locally obtained, the processed GFL inventory is sent back to the entity from which the unprocessed GFL inventory was received before processing, the processed GFL inventory is sent back to the entity where PCL content is supposed to be created, or the processed GFL inventory is sent back to the entity where the GFL inventory is processed.

12. The method of claim 5, wherein a first entity of a PCL information creation or a UE initiating a PDP-context-like information activation procedure, during or before which the GFL inventory is created or processed, requests further PDP-context-like (PCL) information creation needed at a second entity not based on the processed and updated GFL inventory, and the second entity is an entity of the smallest level able to be an entity of an end of PCL information creation.

13. The method of claim 12, wherein if the first entity needs the GFL inventory to request the creation of PCL information at the second entity, the first entity maintains, generates, or receives the GLF inventory through another entity or by itself.

14. A method of creating PDP-context-like (PCL) information in an LTE wireless communications system, the method comprising:
according to a GGSN-inventory-functional-like (GFL) inventory,
a UE initiating a PDP-context-like (PCL) information activation procedure for triggering creation of PCL information at a first entity, or
a first entity initiating a PDP-context-like (PCL) information activation procedure for triggering creation of PCL information at itself;
wherein the first entity is an entity of an end of PCL information creation.

15. The method of claim 14, wherein the GFL inventory does not exist, or is unnecessary if the first entity is the entity of the end of PCL information creation and the first entity performs all or part of functions of SGSN-functional-like entity and GGSN-Functional like entity.

16. The method of claim 14, wherein the GFL inventory is received by the UE at power on if the first entity is the entity of the end of PCL information creation for choosing a first priority entity from the GFL inventory to request the PCL information creation, or the GFL inventory is used at the first entity if the first entity is the entity of the end of PCL information creation for accepting the PCL information creation request or forwarding a request to an entity in the GFL inventory.

17. The method of claim 16, wherein it is mandatory for the first entity to provide the services needed at power on and to have enough capacity, or it is mandatory for the first entity to have abilities of examining the GFL inventory and forwarding the PCL information creation request, or it is mandatory for the first entity to provide the services needed at power on and to have enough capacity as well as to have abilities of examining the GFL inventory and forwarding the PCL information creation request.

18. The method of claim 14, wherein the first entity connects an external network and an internal network to provide routing ability.

19. A method of creating PCL information in an LTE wireless communications system, the method comprising:
a UE initiating a PDP-context-like (PCL) information activation procedure or a first entity of a PCL information creation requests further PCL information creation needed at a second entity based on a GGSN-inventory-functional-like (GFL) inventory if more than one entity is needed for creation of the PCL information;
wherein the second entity is an entity of the smallest level able to be an entity of an end of the PCL information creation.

20. The method of claim 19, wherein if the first entity needs the GFL inventory to request the creation of PCL information at the second entity, the first entity maintains, generates, or receives the GLF inventory through another entity or by itself.

21. The method of claim 19, wherein there are at most three entities needed for the PCL information creation.

22. The method of claim 19, wherein it is mandatory for the first entity to provide services needed at power on, to have enough capacity, or to have abilities of examining the GFL inventory and forwarding the PCL information creation request.

23. A communications device for creating PCL information in a wireless communications system, the communications device comprising:
a control circuit for realizing functions of the communications device;
a processor installed in the control circuit, for executing a program code to operate the control circuit; and
a memory coupled to the processor for storing the program code, the program code comprising:
code for the communications device requesting further PCL information creation needed at a second entity based on a GGSN-inventory-functional-like (GFL) inventory if more than one entity is needed for creation of the PCL information;
wherein the communications device is a UE initiating a PDP-context-like (PCL) information activation procedure or a first entity of a PCL information creation, and the second entity is an entity of the smallest level able to be an entity of an end of the PCL information creation.

24. A communications device for creating PCL information in a wireless communications system, the communications device comprising:
a control circuit for realizing functions of the communications device;
a processor installed in the control circuit, for executing a program code to operate the control circuit; and
a memory coupled to the processor for storing the program code, the program code comprising:
code for the communications device initiating a PDP-context-like (PCL) information activation procedure for triggering creation of PCL information at a first entity or communications device itself;
wherein the first entity is an entity of an end of PCL information creation.
